(19) United States
(12) Patent Application Publication
(10) Pub. No.: US 2006/0123179 A1
(43) Pub. Date: Jun. 8, 2006

(54) Controlling issuance of requests

(76) Inventors: Kar Leong Wong, Teluk Intan (MY); Mikal Hunsaker, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/003,686

(22) Filed: Dec. 3, 2004

(51) Int. Cl. G06F 13/40

(52) U.S. Cl. 710/307

(57) ABSTRACT

Apparatus and method are disclosed that control the issuance of posted and non-posted requests. Some embodiments maintain a specified period between successive non-posted requests on a bus. The specific period may be based upon an expected time for a non-posted request to complete on the bus and the configuration of the link.

### BACKGROUND

A computer system generally comprises processing devices, memory devices, and input-output (I/O) devices. An interface device often couples a processing device and a memory device to one or more I/O devices. For example, an interface device may support transfer of requests from a requesting device to a targeted device and responses from a targeted device back to a requesting device. Peripheral Component Interconnect (PCI) Express is one such interface technology that provides a point-to-point connectivity between I/O devices and interface device coupled to processing and memory devices.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computer system comprising an interface controller.

FIG. 2 illustrates an embodiment of the interface controller depicted in FIG. 1.

FIG. 3 illustrates operation of an embodiment of the interface controller depicted in FIG. 1.

### DETAILED DESCRIPTION

The following description describes a system for controlling issuance of requests. In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

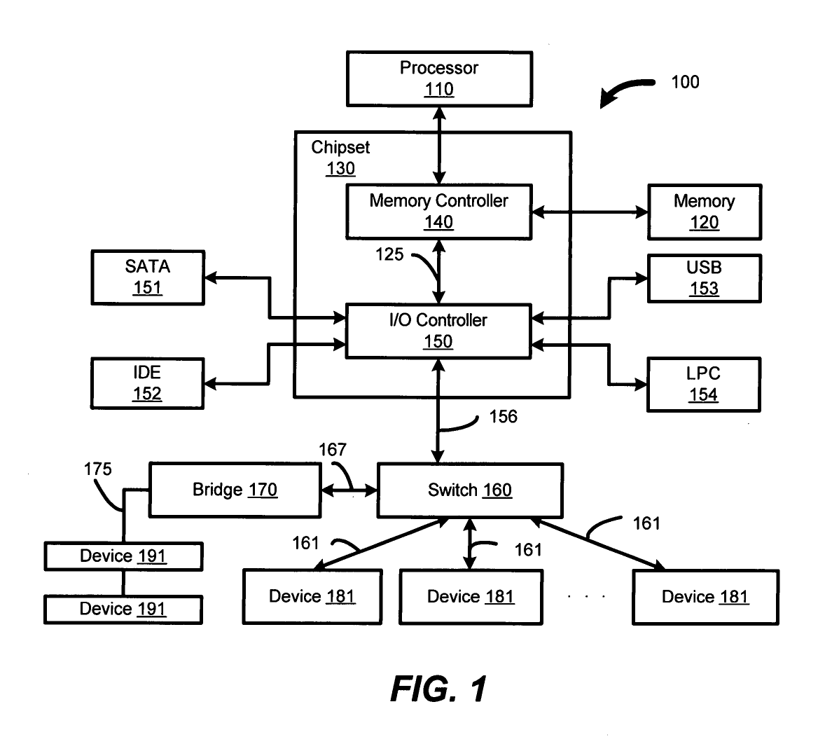

An embodiment of a computer system 100 is illustrated in FIG. 1. The computer system 100 may comprise a processor 110, a memory 120, a chipset 130, a switch 160, a bridge 170, and devices 151, 152, 153, 154, 181, 191. For illustration, I/O controller 150 is shown comprising only one PCI Express port supporting a link 156. However, I/O controller 150 may comprise multiple PCI Express ports, which may support multiple switches such as the switch 160, bridges such as the bridge 170, and devices such as the devices 181, 191.

The processor 110 may manage various resources and processes within the computer system 100 and may execute software instructions as well. The processor 110 may comprise, for example, one or more microprocessors from the Pentium®, Itanium®, or XScale™ family of Intel® microprocessors. The processor 110 may interface with the chipset 130 to receive/send data from/to the memory 120 and the devices 181,191. The memory 120 may store data and/or software and may comprise one or more different types of memory devices such as, for example, DRAM (Dynamic Random Access Memory) devices, SDRAM (Synchronous DRAM) devices, DDR (Double Data Rate) SDRAM devices, or other volatile and/or non-volatile memory devices used in computers.

The bridge 170 may provide connectivity between the switch 160 and the devices 191. The bridge 170 may be coupled to a port of the switch 160 and to a multi-drop parallel interconnect bus 175. The bridge 170 may receive/send packets from/to devices 191 coupled to interconnect bus 175. The switch 160 may receive/send packets from/to the devices 181 directly and from/to the devices 191 via the bridge 170. The switch 160 may also support another switch (not shown) which may be coupled to one of the ports of the switch 160. The switch 160 may forward packets to the chipset 130, to the bridge 170, and/or the devices 181, for example, using address routing, ID routing, and/or implicit routing mechanisms.

The switch 160 may comprise one or more ports to receive/send packets to the chipset 130, the bridge 170, and/or the devices 181. For example, the switch 160 may receive/send packets from/to the devices 181 on corresponding point-to-point links 161 that are coupled to downstream ports of the switch 160. Further, the switch 160 may receive/send packets from/to the devices 191 on a point-to-point link 167 to the bridge 170. The switch 160 may transmit the packets received from devices 181,191 to the chipset 130 on the link 156 that is coupled to an upstream port of the switch 160.

The devices 181, 191 may operate as requesters and/or completers. While operating as a requestor, a device 181, 191 may generate a transaction and while operating as a completer, a device 181, 191 may be addressed by a requestor. For example, a device 181, 191 while operating as a requestor may generate a transaction to read contents of a location in the memory 120. Further, while operating as a completer, a device 181, 191 may complete a received read request by supplying data to the requestor.

The links 156, 161, and 167 may be configured to comprise multiple lanes. Each lane may comprise a set of differential signal pairs, one pair to transmit, and another pair to receive data bytes serially. For example, the link 156 may be configured to comprise 4 lanes, wherein each lane may support serial transfers of packets or portions thereof. In one embodiment, the link 156 may be configured to comprise 1 through 32 lanes. In another embodiment, the number of lanes of link 156 is limited to powers of 2 and in particular 1, 2, 4, 8, 16 or 32 lanes. The link bandwidth may equal the aggregate of the bandwidth corresponding to each lane of the link.

The chipset 130 may comprise one or more integrated circuits or chips that operatively couple the processor 110, the memory 120, and the devices 181, 191. In one embodiment, the chipset 130 may comprise a memory controller 140 and an I/O controller 150 coupled to the memory controller 140 by a bus 125. In one embodiment, bus 125 may comprise a high-speed serial point-to-point bus architecture such as direct media interface (DMI). The chipset 130 may receive packets corresponding to a transaction generated by the devices 181, 191 on links such as the link 156 and may forward the packets to the memory 120 and/or the processor 110 under the control of memory controller 140. Also, the chipset 130 may generate and may transmit transactions to the memory 120, and/or the devices 181, 191 on behalf of the processor 110.

As used herein, a non-posted request refers to a transaction that completes upon receipt of a completion packet, and a posted request refers to a transaction that completes without receipt of a completion packet. A completion packet may indicate termination or partial termination of a transaction sequence. A completion packet may correspond to a preceding request and may include data as well. In one embodiment, non-posted requests comprise read requests, I/O write requests, and configuration write requests, and posted requests comprise memory write requests and message requests.

A packet corresponding to a non-posted request issued by a device 181 may be transmitted towards the chipset 130. In response, the corresponding device 181 may receive a completion packet, which may indicate termination of the transaction. For example, a device 181 while operating as a requestor may issue a read request to read contents of a memory location of the memory 120 and in response may receive a completion packet, which may comprise data read from the requested memory location. Such a completion packet may be routed through the chipset 130 and the switch 160 to the requesting device 181.

The I/O controller 150 may provide an interface between various devices such as PCI Express devices via point-to-point link such as the link 156 and the bus 125. For example, the I/O controller 150 may support a single PCI Express port coupled to link such as the link 156; however, in another embodiment the I/O controller 150 may support multiple PCI Express ports coupled to corresponding links. The I/O controller 150 may receive a number of non-posted requests and posted requests issued by one or more of the devices 181,191 on the link 156. Besides sending and receiving requests, the I/O controller 150 may perform additional functions such as bus arbitration, power management, interrupt controlling, error detection, error reporting, etc. The I/O controller 150 may also support Serial Advanced Technology Attachment (SATA) devices 151, Integrated Drive Electronics (IDE) devices 152, Universal Serial Bus (USB) devices 153, and a Low Pin Count (LPC) devices 154.

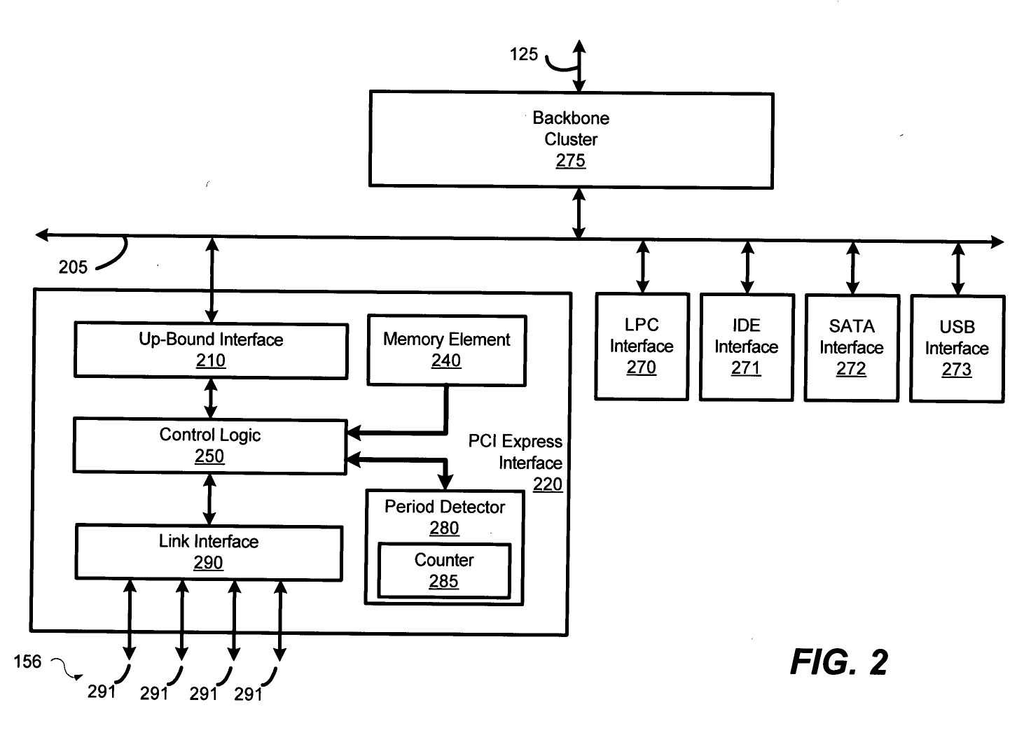

Non-posted requests issued asynchronously before completion of a prior non-posted request may result in a number of outstanding non-posted requests waiting for corresponding completion packets. Such outstanding non-posted requests may flood the computer system 100 and may reduce system performance. An embodiment of the I/O controller 150 is depicted in FIG. 2 that may avoid flooding the computer system 100 with non-posted requests. As depicted, the I/O controller 150 may comprise a PCI Express interface 220, a LPC interface 270, an IDE interface 271, a SATA interface 272, a USB interface 273, and a backbone cluster 275. A backbone bus 205 may couple the backbone cluster 275 to the interfaces 220, 270, 271, 272, 273.

The backbone cluster 275 may couple the backbone bus 205 and the bus 125. In one embodiment, the backbone cluster 275 may comprise multiple queues such as upstream queues, receive queues for non-posted and posted queues, completion queues maintaining the status of completion of non-posted requests etc. The backbone cluster 275 may also comprise timers to check unexpected completions and completion time outs. The backbone cluster 275 may grant the backbone bus 205 to various interfaces such as 220, 270-273 based on, for example, set priorities. In one embodiment, non-posted requests and posted requests received from the PCI Express interface 220 on the backbone bus 205 may be presented on the bus 125.

The LPC interface 270, IDE interface 271, SATA interface, and USB interface 273 may also be coupled to backbone bus 205 and the interfaces may send/receive data on the bus 125 via backbone bus 205 and backbone cluster 275. The data related to the interfaces received on the bus 125 may be sent to corresponding devices 151-154 and the data received from devices 151-154 may be presented on the bus 125.

PCI Express interface 220 may comprise an up-bound interface 210, a memory element 240, control logic 250, a period detector 280, and a link interface 290. The up-bound interface 210 may receive/transmit packets representing non-posted and posted requests and may present the packets on backbone bus 205. The up-bound interface 210 may provide physical, electrical, and protocol interfaces to receive/transmit packets from/to the memory controller 140. The link interface 290 may receive/transmit packets representing non-posted and/or posted requests from/to the devices 181, 191 on lanes 291 of the link 156. The link interface 290 may provide physical, electrical, and protocol interfaces to receive/transmit packets from/to the switch 160.

The memory element 240 may comprise a register, a latch, and/or some other storage device. In one embodiment, the memory element 240 may store a value to specify a throttle period to be maintained between non-posted requests on the bus 205.

The period detector 280 may generate a period detection signal that indicates whether a specified throttle period has elapsed since presenting a non-posted request on the backbone bus 205. The period detector 280 may determine that the specified throttle period has elapsed based on the value stored in the memory element 240. In one embodiment, the period detector 280 may comprise a down-counter 285 that is initialized with a value specified by the memory element 240 in response to presenting a non-posted request on the backbone bus 205. The period detector 280 may decrement the count of the counter 285 once every cycle of a clock signal such as, for example, a system clock signal or an interface clock signal of the I/O controller 150. The period detector 280 may then generate a period detection signal that indicates the throttle period has elapsed in response to the count of the counter 285 reaching a value (e.g. 0 or some threshold value) or the counter 285 detecting an underflow of its count value.

Embodiments may implement the period detector 280 via an up-counter or a down-counter having a period defined by a start count and a stop count, either of which may be defined by an underflow condition, an overflow condition, the memory element 240, and/or default values. Embodiments may also implement the period detector 280 using other circuitry such as, for example, a phase lock loop, a timer, a free running oscillator, and/or an RC (resistor-capacitor) circuit.

The control logic 250 may forward requests from the link interface 290 to the up-bound interface 210 in a manner that may prevent flooding the computer system 100. In particular, the control logic 250 may ensure that at least a specified throttle period is maintained between successive non-posted requests on the backbone bus 205.

To this end, the control logic 250 may identify non-posted requests and posted requests by examining the specific contents of a packet. For example, a transaction layer packet (TLP) of PCI Express interface comprises a header having a type field. The control logic 250 may examine the type field to determine whether a packet corresponds to a non-posted request or posted request.

The control logic 250 may further determine whether a specified throttle period has elapsed since presenting a non-posted request on the backbone bus 205 and may cause a non-posted requested to be presented after the specific throttle period elapses. For example, the control logic 250 may cause the up-bound interface 210 to transmit a first non-posted request on the backbone bus 205. After receiving a period detection signal from the period detector 280 that indicates the throttle period has elapsed since presenting the first non-posted request, the control logic 250 may cause the up-bound interface 210 to present a second non-posted request on the backbone bus 205. However, the control logic 250 may also cause the up-bound interface 210 to present posted requests on the backbone bus 205 independent of the period detection signal. In particular, the control logic 250 may cause the up-bound interface 210 to present a later received posted request between two earlier received non-posted requests if transaction ordering rule permit such a reordering of the requests.

The control logic 250 may store a value in the memory element 240 to specify a specific throttle period to maintain between non-posted requests. In one embodiment, the control logic 250 may store a value of 0 in the memory element 240 to specify a default period between non-posted requests. Further, the control logic 250 may store another value in the memory element 240 to vary the period maintained between non-posted requests. In one embodiment, the control logic 250 may specify the period via the memory element 240 such that the specified throttle period corresponds to an expected period for a non-posted request to complete on the backbone bus 205. In another embodiment, the control logic 250 may specify the period via the memory element 240 such that the specified throttle period corresponds to an expected period for a particular non-posted request presented to the backbone bus 205 to complete.

The control logic 250 may also initialize the period detector 280 after a non-posted request is presented on the backbone bus 205. In one embodiment, the control logic 250 may initialize the period detector 280 by setting a count of a down-counter 285 based upon a value stored in the memory element 240. In another embodiment, the control logic 250 may initialize the period detector 280 by clearing the count of an up-counter 285 to a value of zero. Other embodiments may initialize the period detector 280 using other techniques.

The control logic 250 may configure the link 156 to change the number of lanes comprised in the link 156. The value stored in memory 240 corresponding to the throttle period may be changed based on the number of lanes. In one embodiment, throttle period may be decreased or increased by changing the value stored in memory 240 corresponding to an increase or decrease in the number of bus lanes comprised in the link 156. Changing the throttle period corresponding to a change in the number of lanes may increase the efficiency with which the bandwidth of the system 100 may be utilized while avoiding flooding of the system 100. Since one embodiment limits link 156 to a power of 2 lanes, the control logic 250 may halve the threshold period in response to a doubling of the lanes of link 156, and may double the threshold period in response to a halving of the lanes of the link 156. In particular, the control logic 250 may shift the value stored in the memory 240 to the right by one bit to halve the threshold period and may shift the value left by on bit to double the threshold period.

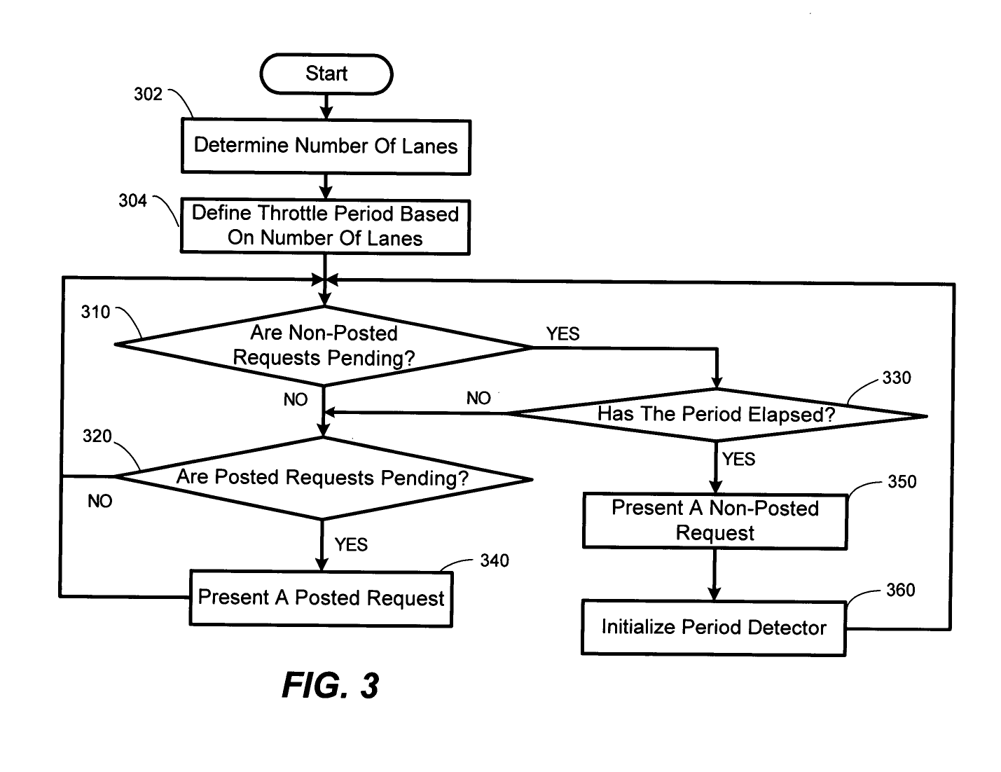

FIG. 3 illustrates operation of an embodiment of the 1/0 controller 150. In block 302, the control logic 250 may determine the number of lanes 291 in the link 156. For example, the control logic 250 may configure the link 156 to comprise four lanes 291. In block 304, the control logic 250 may define the throttle period based on number of lanes 291.

In block 310, the I/O controller 150 may determine whether non-posted requests are pending. In one embodiment, the control logic 250 may determine based upon a type field of packets buffered in the up-bound interface 210. and/or the link interface 290 whether non-posted requests are pending. If no non-posted requests are pending, the I/O controller 150 in block 320 may determine whether posted requests are pending. Again, the control logic 250 in one embodiment may determine based upon a type field of packets buffered in the up-bound interface 210 and/or the link interface 290 whether posted requests are pending. If no posted requests are pending, then the I/O controller 150 may return to block 310 to determine whether any non-posted requests are pending.

If the I/O controller 150 in block 310 determines that non-posted requests are pending, then the I/O controller 150 in block 330 may determine whether a specified period has elapsed since presenting a non-posted request on the bus 125. In one embodiment, the control logic 250 may determine that the period has elapsed based upon whether a period detection signal of the period detector 280 indicates the period has elapsed. If the I/O controller 150 determines that the period has not elapsed, the I/O controller 150 may proceed to block 320 to determine whether a posted request is pending. If the I/O controller 150 determines that a posted request is pending, the I/O controller 150 may present the posted request on the bus 125 in block 340. In one embodiment, the control logic 250 may verify that a pending posted request satisfies transaction ordering rules before presenting the posted request on the bus 125. If there are no pending posted requests that satisfy transaction ordering rules, the I/O controller 150 may return to block 310 without presenting a posted request on the bus 125.

On the other hand, the I/O controller 150 in block 350 may present a non-posted request on the bus 125 after determining that the specified throttle period has elapsed. In particular, the control logic 250 may cause the up-bound interface 210 to present a non-posted request on the bus 125 in response to determining that the period detection signal indicates the specified period has elapsed. The I/O controller 150 may reset or initialize the period detector 280 in block 360 to inform the period detector 280 that a non-posted request was presented and a new period has begun. The I/O controller 150 may then return to block 310 to process another request.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method for a port having a configurable number of bus lines, comprising
setting a throttle period for the port based upon a number of bus lines assigned to the port,
presenting a first non-posted request of the port to a bus, and
presenting a second non-posted request of the port to the bus after determining that the throttle period has elapsed since presenting the first non-posted request to the bus.

2. The method of claim 1 wherein setting comprises setting the throttle period based upon an expected period for the first non-posted request to complete.

3. The method of claim 1 wherein setting comprises setting the throttle period based upon an expected period for non-posted requests to complete on the bus.

4. The method of claim 1 further comprising presenting a posted request of the port to the bus after presenting the first non-posted request to the bus and before determining that the throttle period has elapsed since presenting the first non-posted request to the bus.

5. The method claim 1 wherein setting comprises storing a value to define the throttle period.

6. The method of claim 1 further comprising
changing the number of bus lines assigned to the port, and
updating the throttle period for the port in response to changing the number of bus lines assigned to the port.

7. The method of claim 1 further comprising
increasing the number of bus lines assigned to the port, and
decreasing the throttle period of the port in response to increasing the number of bus lines assigned to the port.

8. The method of claim 1 further comprising
decreasing the number of bus lines assigned to the port, and
increasing the throttle period of the port in response to decreasing the number of bus lines assigned to the port.

9. An apparatus comprising
a first interface to a bus,
a second interface having a configurable number of bus lines, and
control logic to cause the first interface to present a first non-posted request to the bus, to set a throttle period for the second interface based upon a number of bus lines assigned to the port, to determine whether a throttle period has elapsed since presenting the first non-posted request to the bus, and to cause the first interface to present a second non-posted request to the bus after the throttle period has elapsed since presenting the first non-posted request to the bus.

10. The apparatus of claim 9 wherein the throttle period is based upon an expected time for a non-posted request to complete on the bus.

11. The apparatus of claim 9 wherein
the second interface receives the first non-posted request and the second non-posted request, and
the control logic forwards the first request to the first interface, and forwards the second non-posted request to the first interface in response to determining that the throttle period has elapsed since presenting the first non-posted request to the bus.

12. The apparatus of claim 9 wherein the control logic further causes the interface to present a posted request to the bus after presenting the first non-posted request and before the throttle period has elapsed since presenting the first non-posted request to the bus.

13. The apparatus of claim 9 further comprising a counter, wherein
the control logic initializes the counter in response to presenting the first non-posted request on the bus and determines based upon status of the counter whether the throttle period has elapsed since presenting the first non-posted request.

14. The apparatus of claim 9 further comprising a counter, wherein
the control logic sets a count of the counter in response to presenting the first non-posted request and determines based upon status of the counter whether the throttle period has elapsed since presenting the first non-posted request.

15. The apparatus of claim 9 further comprising a counter and a memory element to store a value that is based upon an expected period for a non-posted request to complete on the bus, wherein
the control logic sets a count of the counter based upon the value in response to presenting the first non-posted request and determines based upon status of the counter whether the throttle period has elapsed since presenting the first non-posted request.

16. The apparatus of claim 9 wherein the control logic changes the number of bus lines assigned to the second interface, and updates the throttle period for the second interface in response to changing the number of bus lines assigned to the second interface.

17. The apparatus of claim 9 wherein the control logic doubles the number of bus lines assigned to the second interface, and halves the throttle period for the second interface in response to changing the number of bus lines assigned to the second interface.

18. A system comprising:
a memory controller to process requests to a memory, and
a I/O controller coupled to the memory controller, the I/O controller comprising a first interface having configurable physical bandwidth, a second interface to present requests received by the first interface to the memory controller, and control logic to set a throttle period for the first interface based upon physical bandwidth of the first interface and to ensure at least the throttle period is maintained between successive non-posted requests presented to the memory controller.

19. The system of claim 18 wherein the throttle period is based upon a number of bus lines assigned to the first interface.

20. The system of claim 18 wherein the control logic further causes the second interface to present a posted request of the first interface before the throttle period has elapsed since presenting a non-posted request of the first interface.

21. The system of claim 18 wherein
the I/O interface further comprises a third interface to receive requests, and
the control logic causes the second interface to present a request of the third interface to the memory controller during the throttle period of the first interface.

22. The system of claim 18 wherein the control logic changes the physical bandwidth of the first interface by changing a number bus lines assigned to the first interface, and updates the throttle period based upon the changed physical bandwidth of the first interface.

23. A machine-readable medium comprising a plurality of instructions that in response to being executed result in a computer system
assigning a number of bus lines to a bus interface, and
setting a throttle period for the bus interface based on the number of bus lines assigned to the bus interface.

24. The machine-readable medium of claim 23 wherein the plurality of instructions further result in the computer system
updating a number of bus lines assigned to the bus interface, and
updating the throttle period for the bus interface based on the updated number of bus lines assigned to the bus interface.

25. The machine-readable medium of claim 23 wherein the plurality of instructions further result in the computer system
increasing the number of bus lines assigned to the bus interface, and
decreasing the threshold period for the bus interface in response to increasing the number of bus lines assigned to the bus interface.

26. The machine-readable medium of claim 23 wherein the plurality of instructions further result in the computer system
halving the number of bus lines assigned to the bus interface, and
doubling the threshold period for the bus interface in response to halving the number of bus lines assigned to the bus interface.
